(19) United States
(12) Patent Application Publication
(10) Pub. No.: US 2012/0157581 A1
(43) Pub. Date: Jun. 21, 2012

(54) METHOD FOR PRODUCING A BIODEGRADABLE MATERIAL

(75) Inventors: Nadège Libé, Chatel Guyon (FR); Kareine Rigal, Saint Beauzire (FR)

(73) Assignee: Ulice, Riom (FR)

(21) Appl. No.: 13/381,821

(22) PCT Filed: Jul. 2, 2010
(86) PCT No.: PCT/FR10/51404

§ 371 Date: Feb. 24, 2012

(30) Foreign Application Priority Data
Jul. 3, 2009 (FR) FR 09/03267

(51) Int. Cl. C08L 67/00; B29C 47/14

(52) U.S. Cl. 524/47; 264/555

(57) ABSTRACT

The invention relates to a method for developing a biodegradable material, produced from polymers and meal, wherein the meal is processed with a plasticizing agent in a double screw extruder having a diameter D, over a length of at least 6 D.

The present invention relates to a process for the manufacture of a biodegradable material produced from polymers and flours, preferably cereal flours. Such biodegradable materials are intended to replace the synthetic polymer materials conventionally used in applications such as packaging or the manufacture of films, injection-molded parts and various objects.

The term “biodegradable” is understood to mean, in the context of the present invention, any biological, physical and/or chemical decomposition at the molecular level of substances by the action of environmental factors (in particular enzymes resulting from the metabolic processes of microorganisms). Numerous definitions have been adopted regarding biodegradation (ISO 472-1998, ASTM subcommittee D20-96, DIN 103.2-1993), depending on the standardization organisms, the techniques for measuring the biodegradability and the degradation medium. However, a consensus has emerged in saying that biodegradation may be defined as being the decomposition of organic matter under the action of microorganisms (bacteria, enzymes, fungi) to give carbon dioxide gas, water, biomass, and/or methane.

Mention may thus be made of the standard EN 13432, which defines the requirements relating to packagings which may be recovered in value by composting and biodegradation. The evaluation criteria within the meaning of said standard are as follows:
the material subjected to the test must comprise a minimum of 50% of volatile solids,
the concentration of toxic and dangerous substances identified in the standard (Zn, Cu, Ni, Cd, Pb, Hg, Cr, Mo, Se, As, Fe) must be less than the threshold indicated in the latter,
the biodegradability has to be determined for each packaging material or each significant organic constituent of the packaging, material; the term “significant” is understood to mean any organic constituent representing more than 1% of the dry weight of this material,
the total proportion of organic constituents of undetermined biodegradability must not exceed 5%,
each material subjected to the test must be intrinsically and ultimately biodegradable, as demonstrated by laboratory tests (identical to that of ISO 14851:1999 and 14852:1999), and must be in accordance with the following criteria and levels for acceptance: in an aerobic environment, the percentage of biodegradation of the test material must be equal to 90% in total at least or to 90% of the maximum degradation of an appropriate reference substance once a plateau has been reached both for the test material and for the reference substance (for example cellulose). The duration of the test must be at most 6 months. In an anaerobic environment, the period of the test must be at most 2 months and the percentage of biodegradation, based on the production of biogas, must be greater than or equal to 50% of the theoretical value applicable to the test material.
each material subjected to the test must disintegrate during a biological process for the treatment of the waste: after a composting process of at most 12 weeks, a maximum of 10% of the initial dry weight of the material subjected to a sieving test may form the subject of an oversize for a mesh size of 2 mm.
the final compost must satisfy the European requirements or, failing that, the national requirements relating to the quality of compost.

The various standards make it possible to determine biodegradability characteristics for specific usages.

Thus, in the context of the present invention, a biodegradable material is understood as a material which decomposes according to the definition given above.

The manufacture is known of biodegradable materials based on mixtures between a synthetic polymer and an isolated natural polymer of starch, cellulose, hemicellulose, fiber, hemp fiber, or another type. U.S. Pat. No. 5,095,054 and EP 327 505 describe materials manufactured from a synthetic polymer and a destructured starch. In EP 327 505, the starch is destructured beforehand at temperatures from 130° C. to 190° C. under 5×10⁵ N/m². It is also possible to treat the starch with agents, such as urea or alkali metal or alkaline earth metal hydroxides, as described in European patents EP 400 531 and EP 494 287, or to submit it to a prior chemical treatment in order to modify its surface state and to render its surface hydrophobic. The use of this type of starch is described in particular in the U.S. Pat. No. 6,007,614 and U.S. Pat. No. 5,797,984.

DE 102 30 776 describes the extrusion of a cereal flour plasticized with a mixture of sorbitol and glycerol with a polyester (section [0016], and in particular example 1). The examples mention the use of a twin-screw extruder but do not specify its nature.

US 2006/0043629 describes compositions obtained by mixing a soya flour with glycerol, which compositions are subsequently mixed with a biodegradable polymer (see in particular sections [0093] and [0096]). The flour used is not a cereal flour and thus exhibits strong differences in composition with the flours used in the context of the present invention: soya flour is richer in lipids and proteins than cereal flour, which exhibits a complex carbohydrate composition.

FR 2 856 405 was filed by the Applicant Company and is discussed in this patent application, via the teaching of WO 2004/113433, a patent application of the same family. The teaching of WO 2004/113433 serves as the basis for the comparative examples.

DE 198 02 718 (D4) describes the mixture of corn flour with glycerol and a biodegradable polymer. This mixture is produced all at once, which defines a difference from the subject matter of the process as envisaged, which envisages a plasticizing of the flour before addition of the polymeric agent.

The present invention uses flour, preferably cereal flour, as starting material, in place of isolated starch. This flour indeed contains starch but also other compounds which may influence the quality of the materials obtained, such as proteins, lipids and other sugars less complex than starch. Thus, it is probable that the presence of these other compounds influences the mixing capability of the flour and synthetic polymer.

The manufacture of biodegradable materials from flour is also known in the art, as described in particular in the application WO 00/14154, which specifies certain conditions for the incorporation of cereal flour in a polymer matrix. This patent application mentions in particular that cereal flours are not subjected to any treatment, such as, for example, a gelatinization or destructuring or modification of the surface of the starches, and that plasticizers, such as urea or glycerol, are not used.

The application WO 2004/113433 also relates to mixtures of cereal charges and biodegradable polymer. The cereal charge corresponds to flour which has been transformed using a plasticizing agent to modify its rheological and thermal properties, in order for them to approach those of the biodegradable polymer (production of Thermoplastic Flour). This patent application thus specifies the conditions for mixing the flour and the plasticizing agent. FIG. 6 of this patent application presents an example of the configuration of the screws of a twin-screw extruder for preparing a ThermoPlastic Flour (TPF). Thus, WO 2004/113433 is concerned only with the mixing between the flour and the plasticizer, without studying the result obtained when this product is used with a biodegradable polymer.

The Applicant Company has observed that the conditions for mixing flour and plasticizing agent described in WO 2004/113433 do not make it possible to obtain an optimum mixing between the flour thus transformed and the biodegradable polymer. Thus, the products (films) produced from the biodegradable material obtained according to the process described in WO 2004/113433 do not have suitable mechanical properties.

The present invention thus relates to a process for the manufacture of a biodegradable material from flour and from at least one biodegradable polymer, comprising the stage consisting in
a) transforming said flour by the effect of a plasticizing agent, in order to obtain a transformed flour,
   said stage a) being carried out in a twin-screw extruder, each screw exhibiting the same diameter D, characterized in that said stage a) for the incorporation of the plasticizing agent in the flour is carried out over a length of at least 6 times the diameter of the screw (6×D). Preferably, this incorporation is carried out over a continuous length, that is to say without there being a phase of relaxation of the mixture during the incorporation.

The biodegradable material thus obtained can be referred to as “compound” and is intended to be reworked in the presence or absence of other polymers, in order to obtain biodegradable products, as described in WO 2004/113433 or in WO 2008/003671. It is generally provided in the form of granules.

Thus, this biodegradable material can be mixed with a biodegradable polymer in a single-screw extruder, for use in blown film extrusion.

Blown film extrusion is a known continuous transformation process, in which the granules (compound) enter a heated tube provided with an endless screw. These granules can be of just one type or of several types, when it is desired to produce a mixture. The homogenized material is pushed and compressed and then passes through a die. The polymer thus formed is then expanded with compressed air at the extruder/die outlet. Thus, the outlet of the extruder is vertical and compressed air is blown into the melt, which expands and rises vertically to give a long film bubble. After cooling, rollers flatten the film to give a flat sheath, which is cooled and wound off onto reels. This method is well known for the production of films used in the manufacture of packagings, garbage bags, freezer bags, medical pouches for infusion and thin flexible sheets for coverings for horticultural greenhouses.

In another embodiment, the film is obtained by flat film (or cast film) extrusion. In this method, the polymer falls onto a thermostatically controlled cooling roller at the die outlet. The cold makes it possible to recrystallize and the rotational speed of the rollers makes it possible to adjust the thickness.

It is easy to add several layers of material when this method is used. It is sufficient to produce different polymers in several extruders and to superimpose them at the outlet of the extruders/dies, immediately before the blowing phase (blown film extrusion) or the phase of dropping onto the thermostatically controlled cylinder (flat-film extrusion).

Twin-screw extrusion is a process known to a person skilled in the art. The extrusion machine is more particularly of the copenetrating corotating twin-screw type and comprises two screws, of length L and diameter D, driven in rotation around their axes by a motor and a reducer, inside an elongated jacket forming a barrel surrounded by heating elements. These screws are equipped with helical threads, modular screw elements, which engage with one another, characterized by their outer diameter (od) to inner diameter (id) ratio, which determines the free volume of the screw. The inner wall of the barrel forms two secant lobes with a diameter slightly greater than the outer diameter of the thread. The ratios (od/id) and (L/D) are two important characteristics of the extrusion machine. Whatever the diameter chosen, the ratio of the screw length to the diameter is preferentially greater than 28 and preferably of the order of 40.

It is thus possible to have available a large number of screw elements, making it possible to vary the pitch, the depth, and the number and the length of the screw elements over each working zone. The combination of the elements is referred to as configuration and is characteristic of the objective to be achieved. Thus, it is possible to use elements for the transportation of the material and elements which make it possible to introduce mechanical energy (shearing of the material).

The material advances in the extruder by being pushed by the material introduced at the inlet of the extruder, the throughput being constant.

Generally, an energy of between 0.1 and 0.5 kWh/kg is thus introduced, said energy being introduced mechanically and/or thermally. More preferably, between 0.1 and 0.2 kWh/kg is introduced. The heating elements make it possible to maintain a temperature of between 30 and 190° C.

In a preferred form, the extrusion machine continuously comprises, from the upstream towards the downstream in the direction of transfer of the material, several treatment zones composed, inter alia:
of a zone Z1 for the transformation of the cereal material (mixing with the plasticizing agent in order to obtain a transformed flour),
of a zone Z2 for the introduction of the biodegradable polymer or polymers,
of a zone Z3 for the mixing of the transformed flour and of the biodegradable polymer or polymers.

Stage a) of the process described in the present patent application is thus carried out in the zone Z1, which represents, in a preferred embodiment, at least 35% of the total length L of the extrusion machine. This zone Z1 comprises a zone for introduction of the cereal material (flour) and of the plasticizing agent, a zone for transportation and rise in temperature of these two components, and a zone for mixing these components, which corresponds to the implementation of stage a) of the claimed process.

In a specific embodiment, the total L/D ratio is equal to 40 and the length of the zone Z1 is greater than 16 times D (16D) (for example equal to 18.5 times D (18.5D)).

The modules 1 to 4 in FIG. 6 of WO 2004/113433 correspond to the zone Z1 thus defined. As seen above, no addition of biodegradable polymer is carried out in the extruder described in FIG. 6 (which is read in the light of FIG. 7) of WO 2004/113433. The mixing between the flour and the plasticizer is carried out in module 4. The abbreviations used in this figure correspond to the modular elements carried on the two screws of the extruder: C2F: conjugated double thread (conveying), MAL2 (bilobe kneaders), BL02 (off-centered monolobe on each screw: shearing). Thus, in the process described in WO 2004/113433, the relaxation ranges (transportation carried out by the double threads) are included during the phase of mixing the flour and plasticizing agent. Such elements are described in table 1.19 in the thesis defended by Ika Amalia Kartika on May 19, 2005 in order to obtain the title of Doctor of L'institut National Polytechnique de Toulouse [National Polytechnic Institute of Toulouse] and which is available at the address http://ethesis.inp-toulouse.fr/archive/00000159/01/kartika.pdf, reproduced in FIG. 1.

In a specific embodiment of the process, the incorporation of the plasticizing agent in the cereal material is carried out by the use of modular elements exhibiting a profile which makes possible shearing of the cereal flour/plasticizing agent mixture.

These modular elements will thus lead to a local decrease in the available volume (thus increasing the internal pressure, converted into heat energy) and an increase in the stress per unit of surface area. This is because the modular elements present on the screws furthermore transform the linear flow making possible the transportation/conveying due to the double-thread modular elements into a radial flow.

Such an effect is in particular preferably obtained by the use of modular elements exhibiting a profile of bilobe kneaders (MAL2 in the table of FIG. 1).

In another embodiment, it is possible to use modular elements carrying monolobe kneaders (FIG. 1) or to install, in the zone for transformation of the flour, different modular elements, some being monolobe and others bilobe.

A degree of filling of between 25% and 75% is looked for in this zone for transformation of the flour with the plasticizing agent. This is because the mechanical energy introduced by the kneading elements may not be transmitted to the materials if the degree of filling is too low and the mixing does not take place for an excessively high degree of filling.

The cereal flours which can be used in the context of the present invention are described in WO 2004/113433 or WO 00/14154. Use may in particular be made of flours of T55 wheat, whole wheat, corn or any other cereal. The cereal flour can also be modified by varied techniques, in particular drying, which makes it possible to reduce the water content, or air classification, which makes it possible to separate the cereal material into two different particle size fractions: one richer in starch (large particles) and one richer in proteins (small particles).

The plasticizing Agents which can be used in the present process are natural or synthetic molecules of low molecular weights which make it possible to lower the melting point of the polymer. Use may in particular be made of water (thus an operation is not carried out at low water contents) or another plasticizing agent chosen from the group consisting of glycerol and its derivatives, such as di- or polyglycerol, castor oil, linseed oil, rapeseed oil, sunflower oil, corn oil, polyols, sorbitol and its derivatives, polyol ethers and esters, urea, sodium chloride, alkali metal or alkaline earth metal halides or hydroxides, and mixtures of these. However, a person skilled in the art can use any other known plasticizer which makes it possible to provide a cereal material with which it is combined a rheological behavior identical to or at least very close to that of the polymer of the biodegradable material. Use is preferably made of plasticizers of vegetable origin. Use is preferably made of glycerol, water or a mixture of glycerol and water. A process for producing a biodegradable material from cereal flour and a biodegradable polymer, comprising the transformation of the flour by the effect of a plasticizing agent composed of a mixture of glycerol and water (prior to the mixing with the biodegradable polymer), is also a subject matter of the invention. In this specific case, use may be made of a screw profile which is less shearing than the profile described above, such as the screw profile described in WO 2004/113433. However, the joint use of the shearing screw profile as defined above and of the glycerol/water mixture makes it possible to obtain a better result. In this embodiment, the glycerol:water ratio is between 1.5:1 and 11:1 (weight to weight) and is preferably between 3:1 and 5:1. However, use may also be made of a glycerol:water ratio equal to 1 (between 0.9 and 1.1) or between 0.66 and 1.2.

The term “plasticizing agent” thus covers the use of just one compound or of a mixture of several compounds.

The process according to the invention also preferably comprises a stage b) consisting in mixing said transformed flour obtained with said biodegradable polymer(s). This stage is carried out downstream of the zone Z1 in the twin-screw extruder.

The biodegradable polymer used in the context of the present process can be a vegetable material, such as wood flour, as described in the European patent EP 652 910. It may also be chosen from polyols, as described in the European patent EP 575 349, or copolymers of ε-caprolactone and isocyanates, as described in the European patent EP 539 541.

As indicated above, use is made, in the context of the process according to the invention, of one or more biodegradable polymers.

The biodegradable polymer according to the present invention can be of fossil origin, that is to say a plastic and in particular a thermoplastic. It can be chosen from the group consisting of aliphatic polyesters, aliphatic-aromatic polyesters, aliphatic-aromatic copolyesters and in particular butanediol/adipic acid and terephthalic acid copolyesters, polyamides, polyesteramides, polyethers, polyesteretheramides, polyesterurethanes, polyesterureas and their blends.

It is advantageously chosen from synthetic polymers of fossil origin: family of the copolyesters of butanediol, adipic acid and terephthalic acid, and the blends of these polymers. Use is preferably made of aliphatic aromatic copolyesters, such as described in EP 819 147, in the context of the present invention. In particular, polybutylene adipate/terephthalate (PBAT) is particularly suitable.

It should be noted that, in a specific form of the invention, use is made of a biodegradable polymer of microbial or vegetable origin rather than a polymer of fossil origin. It is then chosen in particular from the group consisting of polylactic acid (PLA) or microbial polymers, such as polyalkanoates of the polyhydroxybutyrate (PHB), polyhydroxyvalerate (PHV) or polyhydroxybutyrate valerate (PHBV) type. Use may also be made of a polymer of the family of the lactones and polycaprolactones or of a blend of polymers of microbial origin and fossil origin.

The polymers poly-ε-caprolactone, polyethylene and polybutylene succinate, polyhydroxybutyrate/hydroxy-valerate, polylactic acid, polyalkylene adipate, polyalkylene adipate/succinate, polyalkylene adipate/caprolactam, polyalkylene adipate/ε-caprolactone, polyadipate of diglycidyl ether/diphenol, poly-ε-caprolactone/ε-caprolactam, polybutylene adipate-co-terephthalate, polyalkylene sebacate, polyalkylene azelate, their copolymers and their blends can be used in the context of the present invention.

Use may also be made of “mixed” polymers obtained by polymerization of monomers of vegetable or microbial origin and of monomers of fossil origin.

In a specific embodiment, use is made of several biodegradable polymers and in particular of the blend of a biodegradable polymer of fossil origin and of a biodegradable polymer of vegetable origin. Use is preferably made of a blend of polybutylene adipate-co-terephthalate (PBAT) and polylactic acid (PLA). Use may thus be made of Ecovio®, developed by BASF (Ludwigshafen, Germany), which is a blend of Ecoflex® and PLA. Ecoflex® has also been developed by BASF and is an aliphatic-aromatic copolyester (PBAT). Use is advantageously made of a blend of Ecoflex® and Ecovio®.

Generally, the prior art describes a large number of polymers which can be used in the context of the present invention.

Various additives can also be incorporated in the materials manufactured. These additives can be inorganic fillers, vegetable fillers, pigments, antiblocking agents, UV absorbers, UV stabilizers, carbon black, mold-release agents or any other acceptable additive.

The cereal flours which can be used in the present process are described in particular in the application WO 2004/113433. Use may thus be made of corn, wheat, barley, soya or rice flours or a flour of any other cereal. The flour used in the process according to the invention usually comprises between 65 and 99% of starch, 2 and 20% of proteins, 0.8 and 15% of fatty substances and 2 and 15% of water. It should be noted that use might be made of other types of flours comprising starch and other polymers, such as potato flours.

In the implementation of the process, use is preferably made of an amount of flour such that the biodegradable material obtained comprises between 15 and 80% (by weight) of flour, preferably between 15 and 60% and more preferably between 20 and 50%. This is because more or less flour is used depending upon the objective desired. If the material is an intermediate material which has subsequently to be mixed with other polymers in order to form biodegradable objects (films, molded or blown objects, and the like), it then advantageously comprises between 30 and 70% of flour. If the material can be used directly for the production of biodegradable objects, it then generally comprises between 15 and 60% of flour.

In the implementation of the process, use is preferably made of an amount of biodegradable polymer (alone or as a mixture) such that the biodegradable material obtained comprises between 10 and 85% (by weight) of biodegradable polymer(s), preferably between 30 and 80%.

The composition of a material obtained by the implementation of the process comprises between 15 and 80% of cereal flour, between 10 and 85% of biodegradable polymer(s) of fossil origin and/or of vegetable origin, and between 2 and 40% of plasticizing agent.

More preferably, this material comprises:
between 20 and 60% of cereal flour, preferably between 30 and 50%,
between 30 and 80% of a biodegradable polymer of fossil origin and/or of vegetable origin selected from aliphatic-aromatic copolyesters, polylactic acids, microbial polymers and their blends,
between 2 and 25% of a plasticizing agent, preferably approximately from 10 to 20%,
between 0 and 5% of urea.

Such a material is also a subject matter of the present invention. The latter thus relates to a biodegradable material comprising a cereal flour transformed by addition of a plasticizing agent and at least one biodegradable polymer, characterized in that the reduced specific viscosity of the amylaceous phase of said material (at a concentration of 3 mg/ml), measured by capillary viscometry, is between 15 and 85 ml/g and preferably between 40 and 85 ml/g.

The intrinsic viscosity of starch samples can vary as a function of its source, as shown by Narpinder Singh et al. in “Structural, thermal and viscoelastic characteristics of starches separated from normal, sugary and waxy maize”, Food Hydrocolloids, 20 (2006), 923-935.

It is thus possible to calculate the relative reduced specific viscosity of the amylaceous phase (Xₑₓ), mentioned by van den Einde et al. in “Molecular breakdown of corn starch by thermal and mechanical effects”, Carbohydrate Polymers, 56 (2004), 415-422, which corresponds to the ratio of the reduced specific viscosity measured for the amylaceous phase to the reduced specific viscosity measured for the flour before transformation (before extrusion). This relative reduced specific viscosity thus clearly reflects the degree of transformation of the flour.

The invention thus also relates to a biodegradable material comprising a cereal flour transformed by addition of plasticizing agent and at least one biodegradable polymer, characterized in that the relative reduced specific viscosity of the amylaceous phase of said material (at a concentration of 3 mg/ml), measured by capillary viscometry, is between 0.10 and 0.65 and preferably between 0.35 and 0.60.

Clearly, such a material is capable of being obtained by a process as described in the present patent application.

The viscosity of the material is indeed representative of the degree of transformation of the cereal flour after being brought into contact with the plasticizing agent.

This is because starch is a natural polymer which exists in the form of granules of 1 to 10 μm, the size and the shape of which vary according to their botanical source. It is composed of two polysaccharide fractions: amylose (generally 20-30%) and amylopectin (70-80%). The amylose (linear polymer) is characterized by the sequence of glucose units bonded to one another via the α-1,4 glucide bonds and exists in the form of a helix. The amylopectin is a branched polymer. It is composed of short chains of glucose units joined via α-1,4 bonds in the linear part and α-1,6 bonds at the branching points.

In the native state, the starch present in the cereal flours is present in the form of granules.

During its transformation, the cereal flour is subjected to a high-temperature treatment in the presence of a plasticizing agent. This transformation is carried out by means of an extruder (generally a twin-screw extruder), the system being subjected to mechanical and thermal energy. The transformation of the cereal flour takes place in several stages:
the swelling of the starch granules of the cereal flour when the mixture (plasticizing agent/cereal flour) reaches its gelatinization temperature. During the swelling of the granules, the amorphous amylose dissolves more or less in the medium. If heating is continued, the residual grains burst and disperse, and amylose/lipid complexes are formed and then crystallize. Thus, the morphology of the cereal flour after transformation by twin-screw extrusion and/or after a second transformation (for example blown film extrusion) can be evaluated by Scanning Electron Microscopy (SEM) after metallization of the samples with gold in order to prevent any phenomenon of electron discharge which would damage the sample analyzed. The accelerating voltage used is rather low: 3 kV.
the partial depolymerization (decrease in the molar masses) by fragmentation of the macromolecules, which can be monitored by solution viscometry.

Consequently, the degree of transformation of the cereal flour can be defined by:
the morphology of the cereal flour/plasticizing agent/polymer(s) mixture by SEM: in particular, it is confirmed whether granules are still present in the mixture.
the degree of degradation of the cereal flour by solution viscometry: this analysis is an indicator of the degree of reduction in the molecular weights of the amylose and of the amylopectin.

Specifically, the cooking of the starch takes place in several states:
the swelling of the starch granules when the mixture (plasticizer(s)/starch) reaches its gelatinization temperature. This phenomenon is reflected by the loss of the semicrystalline structure of the starch (characterized by X-ray diffraction (XRD) by diffractograms of A, B or C type). During the swelling of the granules, the amorphous amylose dissolves more or less in the medium.
if heating is continued, the residual grains burst and disperse, and the following are observed:
   a) the formation of amylose/lipid complexes, which crystallize (XRD diffractograms of V or E type, according to the size of the complexing agent);
   b) the partial depolymerization of the starch (decrease in the average molar mass) by fragmentation of the macromolecules. This stage is that which can be monitored by viscometry.

However, it should be noted that, during storage of a composition comprising preheated starch, the crystalline structure of the starch continues to change: a continuation of the formation of complexes of type V is observed, along with a possible reorganization of the amylopectin into crystalline structures of type B. Consequently, the examination of this composition by XRD is not necessarily representative of the degree of transformation of the starch when it is mixed with the plasticizing agent.

Solution viscometry is an analytical technique which makes it possible to evaluate the depolymerization of starch subjected to a thermal/mechanical treatment (for example of twin-screw extrusion type). At zero concentration, the intrinsic viscosity constitutes a measurement of the molar mass of a polymer since:

[η]=KM^{α}

with [η]=intrinsic viscosity (viscosity at zero concentration)
M=Average molecular weight
K=empirical constant dependent on the solvent/polymer pair
α≈empirical constant dependent on the solvent/polymer pair (generally, α=0.5-1).

[η] corresponds to the extrapolation for a zero concentration of the curve representing the reduced specific viscosity as a function of the concentration. The reduced specific viscosity corresponds to the specific viscosity adjusted for the concentration (see also η_{SP/C} later).

For the products according to the invention, based on starch in potassium hydroxide (KOH) at 1M, α=0.89 and K=8.4×10⁻².

Slight differences in molecular weights are reflected by variations in viscosity.

Capillary viscometry is a simple analytical technique which makes it possible to access the molecular weight of a polymer by determination of the viscosity index. In the claimed material, the variation at a given concentration in the reduced specific viscosity of a dilute solution is virtually linear as a function of the molar mass of the polymer (and is thus related to the degree of the depolymerization of the starch). The choice was made to monitor the reduced specific viscosity and to calculate the relative reduced specific viscosity of a solution of cereal flour at a given concentration, 3 mg/ml.

Thus, the measurement of the relative reduced specific viscosity of the starch is definitely an element for characterization of the average molar mass of the starch which has been subjected to the mechanical and thermal treatment with the plasticizing agent and thus of its degree of transformation (depolymerization). As the structure of the biodegradable material according to the invention is related to the degree of transformation of the starch, the measurement of the viscosity is thus a relevant parameter for the characterization of this material. As seen above, this viscosity measurement is known in the art and is routinely used by a person skilled in the art.

As the claimed biodegradable materials are composed of a flour/plasticizing agent/biodegradable polymer(s) mixture, the degree of transformation of the flour (depolymerization of the starch) is evaluated.
1—Extraction of approximately 60 mg of the cereal flour and drying (extraction carried out on samples of films). The result of the extraction of the cereal flour is referred to as amylaceous phase.
2—Dissolution of the extracted amylaceous phase.
3—Measurement of the reduced specific viscosity at a predetermined concentration (and calculation of the relative reduced specific viscosity at this concentration).

The protocol for measuring the reduced specific viscosity is as follows:

### 1/Extraction and Drying of the Amylaceous Phase

The biodegradable materials according to the invention are composed of a cereal flour/plasticizing agent/biodegradable polymer(s) mixture. In order to study the change in the reduced specific viscosity of the amylaceous phase, it is necessary to extract the biodegradable polymer or polymers present in the mixture. Extraction is carried out on samples of films produced from the biodegradable materials claimed. This stage makes it possible to eliminate the biodegradable polymer and to retain only the amylaceous phase.

In order for the change in the reduced specific viscosity of the extracted amylaceous phase to indeed reflect the degree of transformation of the cereal flour in the biodegradable materials claimed, the film samples are produced on the same blown film extrusion line with identical processing parameters (same temperature profile, same degree of crystallization, same degree of blowing, and the like). The results thus do not depend on the nature of the starting film. Said extraction is carried out using a solvent for the constituent polymer or polymers of the film, which solvent has to be a nonsolvent for the flour.

Various solvents for biodegradable polyesters are presented in the following table (thesis of Emmanuelle Schwach; Etude de systèmes multiphases biodégradables à base d'amidon de blé plastifié Relation structure—Propriétés Approche de la compatibilisation [Study of biodegradable multiphase systems based on plasticized wheat starch. Structure/properties relationship. Compatibilization approach], defended on Jul. 2, 2004 for the attainment of the degree of Doctor, Discipline: Chemistry of Materials, Université de Reims Champagne-Ardenne, doctoral school: Exact Sciences and Biology). These solvents are nonsolvents for the cereal flour and may thus be used for the present extraction according to the biodegradable polymer or polymers of which the biodegradable material is composed.

| Biodegradable polyester | Solvent |
|---|---|
| PLA | CHCl₃ |
| PCL | CHCl₃, THF |
| PBAT | CHCl₃, Hexafluoroisopropanoic acid^{a} (HFIP) |
| PBSA | CHCl₃, CH₂Cl₂ |

^{a}Witt et al., Biodegradation of aliphatic-aromatic copolyesters: evaluation of the final biodegradation and ecotoxicological impact of degradation intermediates, Chemosphere, 44 (2001), 289-299

The amylaceous phase can be isolated by any means known in the art and in particular using a Soxhlet extractor, especially in the case of biodegradable polymers, such as PBAT and PLA. Thus, the polymer PBAT can be extracted with chloroform, as described in the abovementioned thesis by Emmanuelle Schwach. After extraction, the solid amylaceous phase is dried.

### 2/Dissolution of the Extracted Amylaceous Phase

The dissolution of the amylaceous phase extracted from the films obtained from the biodegradable material according to the invention (at a concentration of 3 mg/ml) is carried out in a 1M potassium hydroxide (KOH) solution with stirring at 60° C. for 1 h.

3/Measurement of the Reduced Specific Viscosity of the Amylaceous Phase in Solution at 3 mg/ml (and Calculation of the Relative Reduced Specific Viscosity at this concentration

### Equipment and Analytical Conditions:

Ostwald capillary viscometer
Sample volume introduced into the capillary viscometer: 2 ml
Temperature: 30° C.
Conditioning time before measurement: 3 min
Number of measurements per sample: 3
Solvent: 1M KOH

### Principle of the Measurement:

The viscosity of a liquid, or of infinitely diluted polymer solutions, is proportional to the flow time of a given volume of solution through a capillary. Consequently, the following quantities can be determined:
the viscosity of the solution relative to the viscosity of the pure solvent:

$${η}_{Rel} = \frac{η}{{η}_{0}} = \frac{t}{{t}_{0}}$$

the reduced specific viscosity at a given concentration (reduced specific viscosity):

$${η}_{SP / C} = \frac{1}{C} \times ( {η}_{Rel} - 1 ) = \frac{t - {t}_{0}}{{t}_{0} C}$$

with:
t=flow time of the solution through the capillary
t₀=flow time of the solvent through the capillary
C=the concentration of the solution (in the present case C≈3 mg/ml).

### Calculation of the Relative Reduced Specific Viscosity:

As discussed above, the degree of transformation of the cereal flour brought about by the process for the production of the biodegradable material (twin-screw extrusion) is learnt by monitoring the relative reduced specific viscosity at a given concentration of 3 mg/ml, (Xₑₓ), calculated in the following way:

$${X}_{ex} = \frac{{η}_{SP / C - τ}}{{η}_{SP / C - {τ}_{0}}}$$

with:
   η_{SP/C-τ}=reduced specific viscosity of the flour at a given concentration (C) after thermal/mechanical treatment (twin-screw extrusion in our case)
   η_{SP/C-τ0}=reduced specific viscosity of the flour at a given concentration (C) before thermal/mechanical treatment (twin-screw extrusion in our case)

The invention also relates to plastic films comprising a biodegradable material according to the invention.

Preferably, these films are prepared by blown film extrusion of a biodegradable material according to the invention, alone or by adding another biodegradable polymer, as described above.

These films can be single-layer or multilayer, as described in WO 2008/003671.

The greater degree of transformation of the starch achieved by virtue of the process according to the invention greatly improves the quality of the films which can be produced from the biodegradable material thus obtained, and defined above.

Thus, it is possible to obtain films exhibiting an entirely advantageous haze profile.

By definition, the haze corresponds to the cloudiness of a product caused by the scattering of the light transmitted through the product. This is because the light can be scattered by particles present within the sample (mention may be made, for example, of pigment particles) or by surface defects.

Thus, the optical properties of a sample of plastic film can be determined, inter alia, by measurement of the haze. The latter is defined according to the standard ASTM D1003 as the amount of light which deviates on average by more than 2.5° with respect to the incident light beam. It is expressed as a percentage. A material having a haze of greater than 30% is regarded as scattering. The value of the haze is given by:

$$\% Haze = \frac{{T}_{scattered}}{{T}_{total}} \times 100$$

with: T=transmittance of the incident beam

The protocol for measuring the haze is as follows:

### 1/Preparation of the Samples

3 samples of film with dimensions of 10×10 cm are cut out with a scalpel per reference to be analyzed.

### 2/Determination of the Haze

The tests were carried out according to the ASTM method D1003-07 (November 2007), Haze and luminous transmittance of transparent plastics, Procedure B—Measurement of haze with a spectrophotometer.
Number of test specimens: 3 squares with a length per side of 50 mm per reference
Preconditioning of the samples: 40 h minimum at 23° C.±2° C. and 50%±5% RH
Color-eye 7000A spectrophotometer
Parameters of the spectrophotometer: Illuminant type C, Observer CIE 1931

The use of a biodegradable material according to the invention in the manufacture of plastic films and/or of sheets is also a subject matter of the invention.

### FIGURES

FIG. 1: table in which the effects of the screw elements in a copenetrating and corotating twin-screw extruder are summarized (source: thesis of Ika Amalia Kartika).

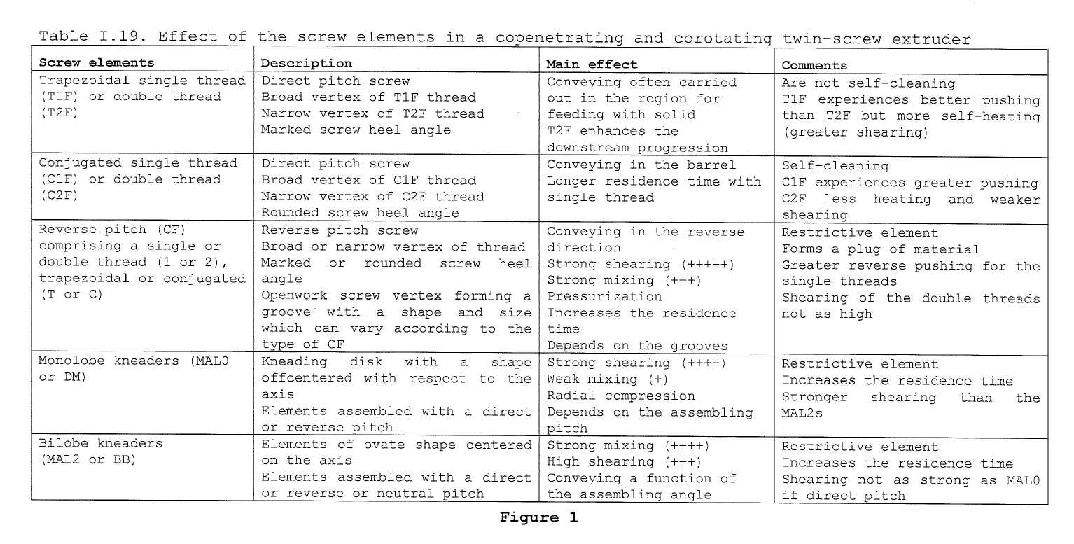

### EXAMPLES

Different screw profiles and different formulations are used.

### Screw Profiles

### Screw Profile C (Control)

Corotating twin-screw extruder, L/D=40, od/id=1.56

Outlet via a die formed of 24 holes of 3 mm

Configuration of the screw (zone Z1):
Transportation, conveying of the flour: 8D
At L=8D, incorporation of the plasticizing agent
Transportation, conveying of the flour/plasticizing agent mixture: 4D
Compression, shearing: 2D
Relaxation/conveying: 0.75D
Compression, shearing: 2D
Transportation, conveying of the transformed
flour: 1.75D

The transformed flour is brought into contact with the biodegradable polymer(s) after a length of 18.5D.

This profile is similar to the profile described in FIG. 6 of WO 2004/113433.

The zone for transformation of the flour thus measures 4.75D and exhibits a relaxation phase.

### Profile A (Process According to the Invention)

Corotating twin-screw extruder, L/D=40, od/id=1.56

Outlet via a die formed of 24 holes of 3 mm

Configuration of the screw (zone Z1):
Transportation, conveying of the flour: 8D
At L=8D, incorporation of the plasticizing agent
Transportation, conveying of the flour/plasticizing agent mixture: 2.25D
Compression, shearing: 6.5D
Transportation, conveying of the transformed flour: 1.75D

The transformed flour is brought into contact with the biodegradable polymer(s) after a length of 18.5D. The zone for transformation of the flour thus measures 6.5D and is without a relaxation phase.

### Formulations Used

### I—Use of Glycerol as Plasticizing Agent

Corn flour: 37%
Glycerol: 16%
PBAT: 47%

### II—Use of Glycerol and Water as Plasticizing Agents

Corn flour: 37%
Glycerol: 13.3%
Exogenous water: 2.7%
PBAT: 47%

### III—Use of Glycerol and Water as Plasticizing Agents

Corn flour: 37%
Glycerol: 12%
Exogenous water: 4%
PBAT: 47%

The percentages are shown by weight: for example, in formulation 1.37 g of flour, 16 g of glycerol and 47 g of PBAT are introduced.

In the present case, all the examples were produced from the same cereal flour. Thus, the change in the reduced specific viscosity directly reflects the degree of transformation of the cereal flour.

Biodegradable materials are thus manufactured. The latter are used for the manufacture of films by blown film extrusion, according to methods known in the art and restated in particular in WO 2008/003671.

The films produced are three-layer films with a thickness of 30 μm and a 20/60/20 structure. The outer and inner layers are composed of PEAT and the central layer of the biodegradable material is obtained after extrusion under the above conditions.

In the present case, the films were produced on a three-layer extrusion station. The station comprises three extruders:
a Dolci 45 feeding the inner layer: screw of PE type, L/D=22
a Reifenhauser 35 feeding the central layer: screw of PE type, L/D=31.4
a Dolci 40 feeding the outer layer: screw of PE type, L/D=32

The processing parameters used for the production of the combination of the films which are studied in the examples are as follows:
Blowing ratio=3.4-3.5
Temperature profile inner layer=120-130-140-150° C.
Temperature profile central layer=110-120-125-130° C.
Temperature profile outer layer=110-120-130-140-150° C.
Filter and die temperature=155° C.

The mechanical properties were measured on a Lloyd LR5K provided with a 100N sensor according to the following operating parameters:
no initial load
gap: 80 mm
pull rate: 100 mm/min
width of the test specimen: 20 mm
failure is detected when the strength suddenly falls

The following is recorded:

% EB=percentage of elongation at break

The surface analysis of the films is carried out on a noncontact surface topography system: AltiSurf® 500. Three surface profiles were acquired under random conditions on the film samples analyzed. The acquisition parameters are as follows:
Probe: 300 m
Length measured: (X): 4.8 mm
Resolution: 1 μm
Acquisition rate: 300 Hz
Measurement rate: 300 μm/s

The following are recorded:

Ra=Arithmetic mean deviation of the roughness profile
Rq=Root mean square deviation of the roughness profile
Pt=Total height of the crude profile

Electron microscopy analysis makes it possible to confirm these data.

### Example 1

The screw profile C and formulation I are used.

A film is produced, as mentioned above.

| | Thick- | | | | |
|---|---|---|---|---|---|
| Product | ness | | Mechanical | Haze | |
| type | (μm) | Topography | properties | (%) | Xₑₓ |
| Film | 30 | Ra: 2.2 | Young's modulus: | 88.8 | 0.75 |
| NLI05/99A2 | | Rq: 2.9 | 110 MPa | | |
| | | Pt: 33.2 | % EB: 380 | | |

The reduced specific viscosity is 99.51 ml/g.

### Example 2

The screw profile A and formulation I are used.

| Product | Thickness | | Mechanical | Haze | |
|---|---|---|---|---|---|
| type | (μm) | Topography | properties | (%) | Xₑₓ |
| Film | 30 | Ra: 1.0 | Young's modulus: | 64.5 | 0.43 |
| NLI05/ | | Rq: 1.2 | 150 MPa | | |
| 102A2 | | Pt: 12.9 | % EB: 430 | | |

An improvement in the Young's modulus and in the elongation at break is thus observed in comparison with the film of example 1. The haze percentage is lower, which shows that the film of example 2 scatters to a lesser extent (allows the light to pass better). This result corroborates the topographical analysis, which shows a marked decrease in the surface roughness of the film. Likewise, the relative reduced specific viscosity decreases, which clearly indicates an increase in the degree of transformation of the cereal flour.

The reduced specific viscosity is 57.04 ml/g.

### Example 3

The screw profile A and formulation II are used.

| | Thick- | | | | |
|---|---|---|---|---|---|
| Product | ness | | Mechanical | Haze | |
| type | (μm) | Topography | properties | (%) | Xₑₓ |
| Film | 30 | Ra: 0.9 | Young's modulus: | 51.7 | 0.43 |
| NLI05/102B | | Rq: 1.1 | 245 MPa | | |
| | | Pt: 13.8 | % EB: 390 | | |

The addition of exogenous water with the glycerol makes it possible in particular to improve the mechanical properties of the films generated (Young's modulus) and their haze.

The reduced specific viscosity is 56.57 ml/g.

### Example 4

The screw profile C and formulation III are used.

| | Thick- | | | | |
|---|---|---|---|---|---|
| Product | ness | | Mechanical | Haze | |
| type | (μm) | Topography | properties | (%) | Xₑₓ |
| Film | 30 | Ra: 1 | Young's modulus: | 58.7 | 0.53 |
| NLI05/99C1 | | Rq: 1.4 | 240 MPa | | |
| | | Pt: 19.7 | % EB: 360 | | |

The reduced specific viscosity obtained is 70.73 ml/g. This example clearly confirms that the use of exogenous water with the glycerol makes it possible to improve the mechanical properties and the haze of the films generated.

### Example 5

The screw profile A and formulation III are used.

| Product | Thickness | | Mechanical | Haze | |
|---|---|---|---|---|---|
| type | (μm) | Topography | properties | (%) | Xₑₓ |
| Film | 30 | Ra: 0.8 | Young's modulus: | 46.8 | 0.38 |
| NLI05/ | | Rq: 1.1 | 250 MPa | | |
| 102C1 | | Pt: 12.2 | % EB: 370 | | |

The reduced specific viscosity obtained is 49.78 ml/g. This example shows that a screw profile/plasticizing agent combination makes it possible to optimize the mechanical, topographical and transparency properties of the films. The degree of transformation of the cereal flour is greater, which is reflected in particular by a lower surface roughness and a lower haze.

### CONCLUSIONS

It is observed that the use of a screw profile leading to greater incorporation of the plasticizing agent in the flour makes it possible to decrease the reduced specific viscosity and the relative reduced specific viscosity, which indicates a greater transformation of the cereal flour.

This effect is also observed when a water/glycerol mixture is used as plasticizing agent, whatever the screw profile used.

The films produced are also of better quality (mechanical quality, as testified by the Young's modulus, and optical quality, as testified by the haze). The use of a screw profile with greater shear and the optimization of the plasticizing agent make it possible to improve the properties of the films produced.

1. A biodegradable material, comprising a cereal flour transformed by incorporation of a plasticizing agent and at least one biodegradable polymer, characterized in that the reduced specific viscosity of the amylaceous phase of said material (at a concentration of 3 mg/ml), measured by capillary viscometry, is between 15 and 85 ml/g.

2. The biodegradable material as claimed in claim 1, characterized in that it comprises between 15 and 80% of flour.

3. The biodegradable material according to claim 1, characterized in that it comprises between 10 and 85% of biodegradable polymer.

4. A process for the manufacture of a biodegradable material as claimed in claim 1 from flour and from at least one biodegradable polymer, comprising the stage:
a) transforming said flour by the effect of a plasticizing agent, in order to obtain a transformed flour,
said stage a) being carried out in a twin-screw extruder, each screw exhibiting the same diameter D, characterized in that said stage a) of transformation of the flour by the plasticizing agent is carried out over a length of at least 6 times the diameter of the screw (6×D).

5. The process as claimed in claim 4, characterized in that the incorporation of the plasticizing agent is carried out by the use of modular elements exhibiting a profile which makes it possible to shear the flour/plasticizing agent mixture, over each of the screws.

6. The process as claimed in claim 5, characterized in that said modular elements exhibit a profile of bilobe and/or monolobe kneaders.

7. The process as claimed in claim 4, characterized in that the plasticizing agent is selected from the group consisting of water, glycerol and its derivatives, such as di- or polyglycerol, castor oil, linseed oil, rapeseed oil, sunflower oil, corn oil, polyols, sorbitol and its derivatives, polyol ethers and esters, urea, sodium chloride, alkali metal or alkaline earth metal halides and mixtures of these.

8. The process as claimed in claim 7, characterized in that the plasticizing agent is a glycerol/water mixture.

9. The process as claimed in claim 4, additionally comprising stage b) mixing said transformed flour obtained with said biodegradable polymer.

10. The process as claimed in claim 9, characterized in that the biodegradable polymer is of fossil origin and is selected from the group consisting of aliphatic polyesters, aliphatic aromatic polyesters, aliphatic-aromatic copolyesters and in particular butanediol/adipic-acid and terephthalic acid copolyesters, polyamides, polyesteramides, polyethers, polyesteretheramides, polyesterurethanes, polyesterureas and their blends.

11. The process as claimed in claim 10, characterized in that the biodegradable polymer is polybutylene adipate-co-terephthalate (PBAT).

12. The process as claimed in claim 9, characterized in that the biodegradable polymer is of vegetable origin and is selected from the group consisting of polylactic acid (PLA) or microbial polymers, such as polyalkanoates of the polyhydroxybutyrate (PHB), polyhydroxyvalerate (PHV) or polyhydroxybutyrate valerate (PHBV) type.

13. The process as claimed in claim 9, characterized in that the biodegradable polymer is a blend of biodegradable polymers of fossil origin and of vegetable origin or is obtained by polymerization of monomers of vegetable or microbial origin and of monomers of fossil origin.

14. The process as claimed in claim 13, characterized in that the biodegradable polymer is a blend of polybutylene adipate-co-terephthalate (PBAT) and polylactic acid (PLA).

15. A plastic film, comprising a biodegradable material as claimed in claim 12.

16. A process for the preparation of a plastic film comprising extruding a biodegradable material as claimed in claim 12 using a blown film extrusion process to form a plastic film of said biodegradable material.

17. The use of a biodegradable material as claimed in claim 12 in the manufacture of plastic films and/or of sheets.

18. A process for the preparation of a plastic film, comprising extruding a biodegradable material as claimed in claim 13 using a blown film extrusion process to form a plastic film of said biodegradable material.

19. A process for the preparation of a plastic film, comprising extruding a biodegradable material as claimed in claim 14 using a blown film extrusion process to form a plastic film of said biodegradable material.
